(19) United States
(12) Patent Application Publication
(10) Pub. No.: US 2026/0200438 A1
(43) Pub. Date: Jul. 16, 2026

(54) ADAPTER FOR A WIPING SYSTEM

(71) Applicant: VALEO SYSTEMES D'ESSUYAGE, La Verriere (FR)

(72) Inventors: Vincent GAUCHER, La Verriere (FR); Stephane HOUSSAT, La Verriere (FR); Olivier JOMARD, La Verriere (FR); Philippe BILLOT, La Verriere (FR)

(73) Assignee: VALEO SYSTEMES D'ESSUYAGE, La Verriere (FR)

(21) Appl. No.: 19/134,848

(22) PCT Filed: Dec. 11, 2023
(86) PCT No.: PCT/EP2023/085205

§ 371 Date: Jun. 2, 2025

(30) Foreign Application Priority Data
Dec. 14, 2022 (FR) FR2213405

(51) Int. Cl. B60S 1/38; B60S 1/40

(52) U.S. Cl. CPC B60S 1/3806; B60S 1/4087

(57) ABSTRACT

The present invention relates to an adapter configured to attach a wiper blade to a drive arm of a wiping system. The adapter includes at least a side wall and a top wall extending mainly in a longitudinal direction and having a first transverse end and a second transverse end. The top wall being connected at its first transverse end to the side wall. According to the invention, the adapter includes at least a first deflection means arranged at the first transverse end and a second deflection means arranged at the second transverse end, with each of the deflection means include a ridge projecting from the top wall.

### TECHNICAL FIELD

The present invention relates to the field of wiper systems intended for motor vehicles, and more particularly to adapters forming part of such wiper systems.

### BACKGROUND OF THE INVENTION

Motor vehicles are commonly fitted with wiper systems that are intended to clean their glazed surfaces, and in particular their windshield. Such wiper systems comprise at least one drive arm and a wiper blade driven by the drive arm. The drive arm is connected to an electric motor of the vehicle and the wiper blade comprises at least one wiper-blade rubber intended to make contact with the glazed surface to be wiped.

In order to be able to replace the wiper blade, a connecting device is arranged between this wiper blade and the drive arm. More particularly, the connecting device comprises an adapter arranged between the drive arm and a connector connected to the wiper blade. The adapter is then secured to the drive arm and more particularly to a free end of this drive arm, such a coupling being reversible so that the wiper blade may be changed once it is worn out.

When the motor vehicle is moving and the wiper system is implemented, a phenomenon of underpressure can lead to wiping defects, or even to the wiper system becoming detached from the windshield to which it is fitted.

One of the solutions enabling this phenomenon of underpressure to be overcome consists in adding a spoiler to the adapter of the wiper system. Such a spoiler, however, presents difficulties in terms of size that are incompatible with the wiping functions and the field of vision of the front occupants of the vehicle.

### SUMMARY OF THE INVENTION

The present invention aims to overcome the abovementioned drawbacks by proposing an adapter having an aerodynamic shape that helps to press the wiper system against the windshield, rather than detaching it therefrom. This pressing is achieved by virtue of the presence of deflection means on the adapter that create successive regions of overpressure and negative pressure.

The main object of the present invention is thus an adapter configured to fasten a wiper blade to a drive arm of a wiper system, comprising at least one side wall and an upper wall extending mainly in a longitudinal direction and having a first transverse end and a second transverse end, the upper wall being connected at its first transverse end to the side wall, these walls contributing to delimiting a volume in which a receiving cavity configured to receive a connector of the wiper system is at least partially arranged. According to the invention, the adapter comprises at least a first deflection means arranged at the first transverse end and a second deflection means arranged at the second transverse end, each of the deflection means comprising at least one ridge projecting from the upper wall.

The adapter according to the invention is intended to be integrated within a wiper system in order to be fitted to a glazed surface of a motor vehicle. The adapter comprises an upper wall that is transversely delimited by a first transverse end and a second transverse end, the first of these transverse ends being continued by a side wall. The second transverse end may alternatively be connected to another side wall or else be free. The adapter comprises deflection means, which have the role of creating disturbances in an air flow that is projected onto the adapter. More specifically, these deflection means make it possible to form a succession of regions of overpressure and negative pressure on a surface of the adapter, thereby contributing to pressing the adapter against the glazed surface that the wiper system of which it forms part is intended to wipe. For this purpose, the deflection means are arranged at each of the transverse ends of the upper wall; it will thus be understood that they border this upper wall.

The deflection means are ridges that project from the upper wall, i.e. they form protuberances on this otherwise substantially flat upper wall.

According to one feature of the invention, the ridge comprises an edge and two flanks, this edge and these two flanks projecting from the upper wall.

The edge of the ridge makes it possible to join the two flanks. It is the furthest projecting point of a given deflection means.

According to another feature of the invention, at least one of the deflection means extends, and advantageously all of the deflection means extend, along the entire length of the adapter.

The deflection means can therefore contribute to pressing the adapter onto the glazed surface of the vehicle over an entire length of this adapter.

According to one feature, the first deflection means contributes to forming a leading edge of the adapter, while the second deflection means contributes to forming a trailing edge of the adapter.

In this case, “leading edge” is understood to mean a portion of the adapter that is the first to be in contact with a given air flow, and “trailing edge” is understood to mean a portion of the adapter at which this air flow leaves the adapter. The first deflection means will therefore receive the air flow before the second deflection means.

According to one feature, the adapter comprises at least one additional deflection means arranged transversely between the first deflection means and the second deflection means.

This additional deflection means, which corresponds for example to a third deflection means, is arranged transversely between the first and second deflection means. As a result, this additional deflection means is arranged on the upper wall between its first transverse end and its second transverse end.

According to another feature of the invention, the deflection means are superposed with a transverse offset.

The deflection means are superposed in the sense that they are at different distances from the glazed surface, but they are transversely offset since at least one is arranged at the first transverse end and another is arranged at the second transverse end. The deflection means therefore have a stepped configuration. By way of example, for an embodiment with a third deflection means as mentioned above, an edge of the first deflection means will be arranged vertically lower than an edge of the third deflection means, itself being arranged vertically lower than an edge of the second deflection means.

According to one feature, at least one of the deflection means has a varying height or is longitudinally discontinuous.

The height of the deflection means, which is its dimension measured substantially perpendicular to the upper wall, may alternatively be increasing or decreasing. For example, it would be possible to envisage a deflection means having a greater height in the vicinity of a first longitudinal end of the adapter compared with another height measured at a second longitudinal end of the adapter. Such a variation in the height of the deflection means makes it possible to modify its capacity to generate a negative pressure or an overpressure along the longitudinal direction of the adapter. According to one example of discontinuity, the deflection means may have a cutout.

According to one feature of the invention, the upper wall and/or the side wall have/has a convex shape when viewed from the front.

According to another feature, the side wall has an extension wall with a concave shape when viewed from the front.

The upper wall and the side wall, and optionally the extension wall of this side wall, are therefore recessed and then domed when respectively viewed from the front. Such a configuration makes it possible, in combination with the deflection means, the ridge of which creates a concave shape when viewed from the front, to obtain an alternation between convex shapes and concave shapes on an adapter surface exposed to the air flow, thereby contributing to disturbing the air flow so as to create a succession of regions of overpressure and negative pressure.

The invention also relates to a wiper system comprising a drive arm, a wiper blade, a connector and an adapter such as described in the present document

### BRIEF DESCRIPTION OF DRAWINGS

Other features, details and advantages of the invention will become more clearly apparent on reading the following description, and from studying exemplary embodiments given by way of non-limiting indication, with reference to the appended drawings, in which:

FIG. 1 schematically illustrates a perspective view of a wiper system comprising an adapter according to the invention;

FIG. 2 schematically illustrates a perspective view of the adapter of the wiper system in FIG. 1;

FIG. 3 schematically illustrates a sectional view of the adapter in FIG. 2 along section A-A shown in FIG. 2; and

FIG. 4 schematically illustrates an alternative embodiment of the adapter in FIG. 2.

The features, variants and various embodiments of the invention may be combined with one another, in various combinations, as long as they are not mutually incompatible or mutually exclusive. It will be possible, in particular, to conceive of variants of the invention that comprise only a selection of the features described below, in isolation from the other features described, if this selection of features is sufficient to confer a technical advantage and/or to distinguish the invention from the prior art.

### DETAILED DESCRIPTION OF THE INVENTION

In the figures, elements that are common to multiple figures retain the same reference sign.

In the following detailed description, the terms “longitudinal”, “transverse” and “vertical” refer to the orientation of the adapter according to the invention. A longitudinal direction corresponds to a main direction of elongation of this adapter, this longitudinal direction being parallel to a longitudinal axis L of a coordinate system L, V, T illustrated in the figures. A transverse direction corresponds to a direction in which the first transverse end and the second transverse end are at opposite ends, this transverse direction being parallel to a transverse axis T of the coordinate system L, V, T and this transverse axis T being perpendicular to the longitudinal axis L. Finally, a vertical direction corresponds to a direction parallel to a vertical axis V of the coordinate system L, V, T, this vertical axis V being perpendicular to the longitudinal axis L and to the transverse axis T.

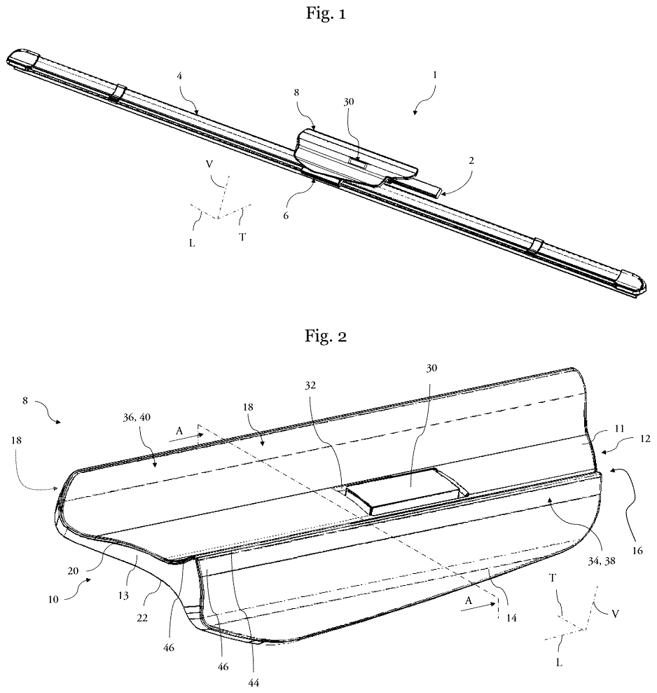

FIG. 1 thus schematically illustrates a wiper system 1. This wiper system 1 is intended to clean a glazed surface of a vehicle, for example a windshield, so as to improve a driver's visibility of the road in front of the vehicle. The wiper system 1 comprises at least one drive arm 2, only a portion of which is shown here, bearing, at one end, a wiper blade 4 that extends mainly in the longitudinal direction L.

Within the wiper system 1, the drive arm 2 and the wiper blade 4 are associated with one another by means of a connection device involving a connector 6 and an adapter 8, this adapter 8 covering the connector 6. More particularly, the connector 6 is secured to the wiper blade 4 while the adapter 8 is secured to the drive arm 2, the adapter 8 and the connector 6 being coupled via a pivot connection.

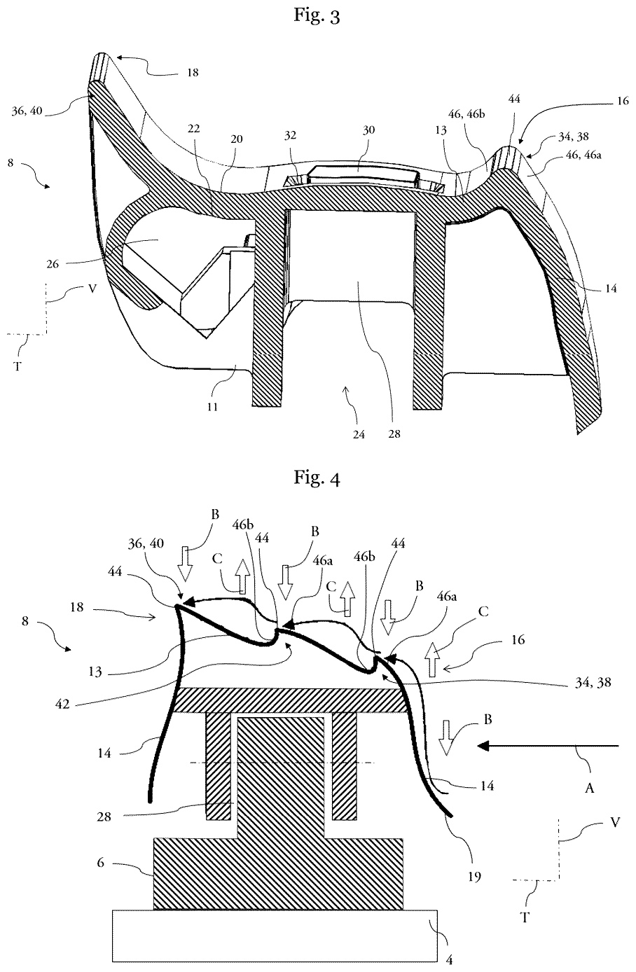

The adapter 8 will now be described in greater detail with reference to FIG. 2 to FIG. 4. The adapter 8 extends in a main direction of elongation that corresponds to a longitudinal direction L. It has a first longitudinal end 10 and a second longitudinal end 12 that are at opposite ends in this longitudinal direction L. The adapter 8 has a main body 11 that is formed by an upper wall 13 and at least one side wall 14. The adapter 8 may, depending on the embodiments, comprise one or two side walls 14. A first embodiment having an adapter 8 with a single side wall 14 is illustrated in FIG. 2 and FIG. 3, while FIG. 4 shows a second embodiment with two side walls 14.

The upper wall 13 and the one or more side walls 14 extend mainly in the longitudinal direction L. The upper wall 13 is delimited transversely by a first transverse end 16 and by a second transverse end 18.

As shown in FIG. 3, the first transverse end 16 forms a join between the upper wall 13 and the side wall 14; in other words, the upper wall 13 and the side wall 14 are connected at the first transverse end 16. In the embodiments having two side walls 14, the second transverse end 18 forms an intersection between the upper wall 13 and the other side wall 14.

When viewed from the front, i.e. according to the viewpoint in FIG. 2, the upper wall 13 and the side wall 14 arranged at its first transverse end 16 have a convex shape. This side wall 14 may, in certain embodiments and as illustrated in FIG. 4, have an extension wall 19 that forms an extension in the overall vertical direction V. In this case, this extension wall 19 has a concave shape when viewed from the front, as can be seen from FIG. 4 from the perspective of the arrow with the reference sign A.

These convex or concave shapes of the upper wall 13, of the side wall 14, and optionally of the extension wall 19, contribute to disturbing an air flow A, represented by a black arrow in FIG. 4, when the latter arrives close to the adapter 8.

The upper wall 13 has an upper face 20 and a lower face 22 that are on opposite sides to one another in a vertical direction V. The lower face 22 is intended to face the connector 6, the wiper blade 4 and the drive arm 2. To this end, the upper wall 13 and the one or more side walls 14 are arranged so as to delimit a volume 24 of the adapter 8 between them, this volume 24 being in particular shown in FIG. 3 and FIG. 4.

The volume 24 contains a plurality of indentations intended to house components of the wiper system 1, which are particularly clearly shown in FIG. 3. In terms of these indentations, the volume 24 in particular comprises a receiving housing 26 configured to receive the drive arm 2 and a receiving cavity 28 configured to receive the connector 6.

The receiving housing 26 is formed within the volume 24 from the lower face 22; more specifically, it extends therefrom along the second transverse end 18 of the upper wall 13. The drive arm 2 is able to slide within the adapter 8 until it comes into abutment against its receiving recess 26.

Similarly, the receiving cavity 28 extends from the lower face 22 and at a distance therefrom at least partially into the volume 24. It has the shape of a rectangular parallelepiped and is centered transversely within the volume 24; in other words, it should be understood that the receiving cavity 28 is substantially equidistant from each of the transverse ends 16, 18 of the upper wall 13. The receiving cavity 28 receives the connector 6 such that the latter is interlocked therein when it is integrated into the wiper system 1.

The adapter 8 comprises, in order to be locked to or unlocked from the drive arm 2, a locking device 30. The role of this locking device 30 is to prevent or allow a translational movement of the drive arm 2 with respect to the adapter 8. For this purpose, the locking device 30 comprises a push button that is flush with the upper wall 13 of the adapter 8. The locking member 30 is arranged within an opening 32 that is formed in this upper wall 13 and extends from the upper face 20 to the lower face 22 of this wall. In this case, the locking member 30 has a substantially rectangular shape. It is arranged, on the upper wall 13, so as to be substantially equidistant from the two transverse ends 16, 18.

According to the invention, the adapter 8 comprises at least two deflection means 34, 36 that contribute to disturbing the air flow A when it comes into contact with the adapter 8. In particular, the presence of these deflection means 34, 36 makes it possible to form, on the upper face 20 of the upper wall 13, a succession of regions of overpressure and negative pressure, which increases the pressing of the adapter 8 on the glazed surface to which it is fitted.

In the first embodiment of FIG. 2 and FIG. 3, the adapter 8 more specifically has a first deflection means 34 and a second deflection means 36, the first deflection means 34 being arranged at the first transverse end 16 of the upper wall 13 and the second deflection means 36 being arranged at the second transverse end 18 of this same upper wall. It should thus be understood that the first deflection means 34 and the second deflection means 36 are at opposite ends in the transverse direction T.

The first deflection means 34 forms a leading edge 38 of the adapter 8, i.e. a front edge that is intended to receive the air flow A first. Conversely, the second deflection means 36 forms a trailing edge 40 of the adapter 8, which is a rear edge at which the air flow A leaves the adapter 8.

In the second embodiment shown in FIG. 4, the adapter comprises at least one additional deflection means 42, which in this case is a third deflection means 42. This third deflection means 42 is arranged transversely between the first deflection means 34 and the second deflection means 36. As shown in FIG. 4, the third deflection means 42 is substantially equidistant from the first transverse end 16 and the second transverse end 18.

These deflection means 34, 36, 42 may be separate elements that are fastened to the upper wall 13. Preferably, they are protuberances on the upper wall 13, i.e. they are made of the same material as the latter, as is the case in the two embodiments illustrated here. The deflection means 34, 36, 42 extend along the longitudinal direction L, from the first longitudinal end 14 to the second longitudinal end 16. These deflection means 34, 36, 42, whether there are two or three, may extend over the entire length of the adapter 8 or only over part of this length, thus forming deflection means that are shorter than the adapter or a discontinuity along these deflection means 34, 36, 42.

Both in the first embodiment and in the second embodiment, each deflection means 34, 36, 42 comprises a ridge that projects from the upper wall 13. Thus, when the deflection means 34, 36, 42 is viewed in section as is the case in FIG. 3 or FIG. 4, it has an elevated profile, i.e. elevated above the upper wall 13.

A ridge corresponds to an assembly formed by an edge 44 and two flanks 46 bordering this edge 44, the assembly projecting from the upper wall 13. In other words, the edge 44 constitutes the furthest projecting point of a given deflection means 34, 36, 42, the two flanks 46 extending on either side of this edge 44 in the longitudinal direction.

According to an advantageous aspect, a first flank 46a is convex, considering the adapter 8 from the front, while a second flank 46b is concave from the same viewpoint.

In FIG. 2 and FIG. 3, only the first deflection means 34 is formed in this manner. The second deflection means 36 has only a first concave flank, a convex portion then being formed at the join between the upper wall 13 and the second deflection means 36.

As is particularly clearly shown in FIG. 2, at least one of the deflection means 34, 36 has a constant height, i.e. a dimension measured between a point on its edge 44 and a closest point on the lower face 22 of the upper wall 13 is constant over an entire length of the deflection means 34, 36.

Alternatively, and despite not being illustrated in the figures, it would be possible to envisage deflection means 34, 36, 42 that, by contrast, have a varying height. Their height could then vary between the first longitudinal end 10 and the second longitudinal end 12.

By way of example, the deflection means 34, 36, 42 could have a greater height at the first longitudinal end 10 than at the second longitudinal end 12, or else the deflection means 34, 36, 42 could have similar heights close to each of the first and second ends 10, 12 but have a reduced or even increased height at a central longitudinal portion of the deflection means 34, 36, 42.

Furthermore, without departing from the scope of the invention, it would be possible to imagine embodiments in which at least one deflection means 34, 36, 42 is discontinuous. It would then be possible to envisage a cutout in this or these deflection means 34, 36, 42.

As illustrated in particular in FIG. 3 and FIG. 4, the deflection means 34, 36, 42 are arranged in a stepped configuration. This means that these deflection means 34, 36, 42 are superposed on one another while exhibiting an offset in the transverse direction T. This results in, for example for the second embodiment with three deflection means 34, 36, 42, the edge 44 of the first deflection means 34 being arranged vertically lower than the edge 44 of the third deflection means 42, which is itself arranged vertically lower than the edge 44 of the second deflection means 36.

As mentioned above, the presence of deflection means 34, 36, 42 as well as the particular shape of the walls 12, 14, 19 of the adapter 8 contributes to disturbing a flow of the air flow when the latter is close to the adapter 8. Such a disturbance will now be described in greater detail with reference to FIG. 4.

The air flow A circulates transversely along the adapter 8 at its extension wall 19 and its side wall 14. Since the extension wall 19 has a concave shape when viewed from arrow A, it generates an overpressure of the air flow A at its location, such an overpressure being represented here by an arrow B directed downwards. Conversely, the side wall 14 has a convex shape when viewed from the front, i.e. from arrow A, this generating a negative pressure represented by an arrow C facing upwards.

The edge 44 of a deflection means 34, 36, 42 forms a boundary between, on one side, the first flank 46a upstream of the edge 44, in the direction of movement of the air flow A, thereby generating an overpressure B, and, on the other side, the second flank 46b, downstream of the edge 44 in the direction of movement of the air flow A, thereby generating a negative pressure C. This alternation of peaks and troughs, and consequently this succession of regions of overpressure and negative pressure, increases the pressing of the adapter 8 against the glazed surface to which it is fitted.

The present invention thus proposes an adapter having an aerodynamic shape provided with deflection means that makes it possible to increase the pressing of the wiper blade against the glazed surface that the wiper system is intended to wipe.

However, the present invention is not limited to the means and configurations described and illustrated here and it also extends to any equivalent means and configurations and to any technically operational combination of such means

What is claimed is:

1. An adapter configured to fasten a wiper blade to a drive arm of a wiper system, comprising at least one side wall and an upper wall extending mainly in a longitudinal direction and having a first transverse end and a second transverse end, the upper wall being connected at the first transverse end to the side wall, the at least one side and the upper wall contributing to delimiting a volume in which a receiving cavity configured to receive a connector of the wiper system is at least partially arranged, the adapter includes at least a first deflection means arranged at the first transverse end and a second deflection means arranged at the second transverse end, each of the deflection means including at least one ridge projecting from the upper wall.

2. The adapter as claimed claim 1, wherein the ridge includes an edge and two flanks, with the edge and the two flanks projecting from the upper wall.

3. The adapter as claimed in claim 1, wherein at least one of the deflection means extends along an entire length of the adapter.

4. The adapter as claimed in claim 1, wherein the first deflection means contributes to forming a leading edge of the adapter, while the second deflection means contributes to forming a trailing edge of the adapter.

5. The adapter as claimed in claim 1, further comprising at least one additional deflection means arranged transversely between the first deflection means and the second deflection means.

6. The adapter as claimed in claim 5, wherein the deflection means are superposed with a transverse offset.

7. The adapter as claimed in claim 1, wherein at least one of the deflection means has a constant height along an entire length of the adapter.

8. The adapter as claimed in claim 1, wherein at least one of the deflection means has a varying height or is longitudinally discontinuous.

9. The adapter as claimed in claim 1, wherein the upper wall and/or the side wall includes a convex shape.

10. A wiper system comprising a drive arm, a wiper blade, connector and an adapter, wherein the adapter includes at least one side wall and an upper wall extending mainly in a longitudinal direction and having a first transverse end and a second transverse end, the upper wall being connected at the first transverse end to the side wall, the at least one side and the upper wall contributing to delimiting a volume in which a receiving cavity configured to receive the connector, the adapter includes at least a first deflection means arranged at the first transverse end and a second deflection means arranged at the second transverse end, each of the deflection means including at least one ridge projecting from the upper wall.
